(19) United States
(12) Patent Application Publication
(10) Pub. No.: US 2026/0062968 A1
(43) Pub. Date: Mar. 5, 2026

(54) LOCKING DEVICE FOR LOCKING A PIVOTABLY MOUNTED DOOR OF A CONTAINER, IN PARTICULAR A LUGGAGE COMPARTMENT DOOR OF AN OVERHEAD LUGGAGE COMPARTMENT, AND OVERHEAD LUGGAGE COMPARTMENT WITH SUCH A LOCKING DEVICE

(71) Applicant: FACC AG, Ried im Innkreis (AT)

(72) Inventors: Bernhard KAMMERER, Zell an der Pram (AT); Lukas KLEMBARA, Bratislava (SK)

(21) Appl. No.: 19/101,203

(22) PCT Filed: Aug. 9, 2023
(86) PCT No.: PCT/AT2023/060270

§ 371 Date: Feb. 4, 2025

(30) Foreign Application Priority Data
Aug. 10, 2022 (AT) A 50617/2022

(51) Int. Cl. E05C 3/16; B64D 11/00; E05B 15/04; E05B 41/00

(52) U.S. Cl. CPC E05C 3/162; B64D 11/003; E05B 15/04; E05B 41/00

(57) ABSTRACT

Locking device for locking a door of a container in the closed position, with a housing, a hook for hooking into a retaining axis, an operating handle for unlocking the hook, the hook being actuatable by the operating handle via a catch that when the operating handle is moved, the hook can be moved out of the closed position, the operating handle being freely movable around a predetermined angle range before the hook can be unlocked, and with an indicator for identification of an incompletely locked state of the door, and overhead luggage compartment with a locking device. The indicator is arranged on at least one lateral outer surface of the operating handle and perpendicular to the axis of rotation for the operating handle.

### CROSS REFERENCE TO RELATED APPLICATIONS

The present application is a U.S. National Phase of International Application No. PCT/AT2023/060270 entitled “LOCKING DEVICE FOR LOCKING A PIVOTABLY MOUNTED DOOR OF A CONTAINER, IN PARTICULAR A LUGGAGE COMPARTMENT DOOR OF AN OVERHEAD LUGGAGE COMPARTMENT, AND OVERHEAD LUGGAGE COMPARTMENT WITH A LOCKING DEVICE OF THIS TYPE,” and filed on Aug. 9, 2023. International Application No. PCT/AT2023/060270 claims priority to Austrian Patent Application No. A 50617/2022 filed on Aug. 10, 2022. The entire contents of each of the above-listed applications are hereby incorporated by reference for all purposes.

### TECHNICAL FIELD

The invention relates to a locking device for locking a pivotably mounted door of a container, in particular a luggage compartment door of an overhead luggage compartment, in the closed position, with a housing, at least one hook pivotably spring-mounted on the housing about an axis of rotation for hooking into a retaining axis arranged on the container in the closed position, an operating handle pivotably spring-mounted on the housing about an axis of rotation for unlocking the at least one hook hooked in the closed position, wherein the axis of rotation for the at least one hook and the axis of rotation for the operating handle are arranged essentially coincident on the housing, the at least one hook can be actuated by the operating handle via at least one catch non-rotatably connected to the operating handle in such a way that when the operating handle is moved via the at least one catch, the at least one hook can be moved out of the closed position, the operating handle being freely moved around a predetermined angle range before the at least one hook can be unlocked, and with at least one indicator for indicating an incompletely locked state of the door.

### BACKGROUND AND SUMMARY

Furthermore, the invention relates to an overhead luggage compartment with a fixed container and a luggage compartment door pivotable via at least one hinge and an above-mentioned locking device for locking the luggage compartment door in the closed state. The present invention relates mainly to overhead luggage compartments and their locking devices for passenger aircraft. However, an application to rail vehicles or other means of transportation designed for passenger transport, for example ships, is also conceivable.

In the case of overhead luggage compartments for aircraft, a distinction is made between fixed luggage compartments (fixed bins) with a fixed part and a hinged luggage compartment door and movable luggage compartments (movable bins) with a lowerable tray or chute and an enclosure or housing. The present invention relates to fixed overhead luggage compartments (fixed bins) with a pivoting luggage compartment door, which is held in the closed position by a locking device. Overhead luggage compartments are usually made of composite materials made of fiber-reinforced plastic and a honeycomb core in lightweight construction. The luggage compartment door of fixed overhead luggage compartments and the tray of movable overhead luggage compartments are usually moved manually. Particularly in the case of very large overhead luggage compartments with a large volume for accommodating items of luggage, the movement can be supported by force assist elements or even electric drives.

A simply designed and easy-to-operate locking device, in particular for overhead luggage compartments for aircraft, with a rotatable hook and sliding operating handle is known, for example, from EP 0 166 723 B1.

If a locking device of an overhead luggage compartment is not closed properly, for example because an object, e.g. an item of clothing, is caught between the hook and the retaining axis, there is a risk that the luggage compartment door will open during the flight and pieces of luggage will fall out of the overhead luggage compartment and injure passengers. For this reason, there are indicators or indications that show the flight crew an incompletely locked state of the locking device so that it can be ensured that all overhead luggage compartments are properly closed before take off of the aircraft. Known indicators for the identification of an incompletely locked state of the luggage compartment door usually comprise a bright color and are located on the side of the operating handle, which protrudes slightly when the luggage compartment is insufficiently locked, whereby the bright color of the indicator is intended to come to light. With known locking devices of this type, the indicator is often not reliable and does not provide sufficient security. The situation is made more difficult by the fact that, particularly in the case of very large overhead luggage compartments, which can hold a very large volume of luggage, the deflection of the fixed part of the luggage compartment is relatively large and proper locking of the locking device is not possible or only possible with difficulty.

More complex electronic methods are known from the prior art, which are intended to indicate a malfunction of the locking device. For example, U.S. Pat. No. 7,302,150 B2 describes a movable overhead luggage compartment (movable bin) in which light sources and optical fibers are used to detect and indicate incomplete locking. The disadvantages of this are the greater expense and the involvement of electro-optical components.

U.S. Pat. No. 7,552,954 B2 discloses a mechanism in a movable overhead luggage compartment in which the operating handle remains open as long as both locking devices are not properly closed.

US 2003/0146629 A1 describes a complicated locking device for overhead luggage compartments, which is supposed to function optimally even when the luggage compartments are deflected. However, an indicator for identification of an incompletely locked state of the luggage compartment door is not described.

The object of the present invention is to create an above-mentioned locking device and an overhead luggage compartment with such a locking device, by means of which a more reliable locking is achieved even in the event of tolerance- or load-related deflection of the container, in particular of the fixed part of the overhead luggage compartment, and optimum functioning is ensured. Nevertheless, in the event of an incompletely locked state of the locking device, this state should be reliably indicated so that such an unwanted and potentially dangerous state can be reliably detected and appropriate countermeasures can be taken. The locking device should be as simple and inexpensive as possible to manufacture and free of electronic components. Disadvantages of comparable devices should be avoided or at least be mitigated.

The object according to the invention is solved by an above-mentioned locking device, in which the at least one indicator for the identification of an incompletely locked state of the door is arranged on at least one lateral outer surface of the operating handle and essentially perpendicular to the axis of rotation for the operating handle. Such an arrangement of the at least one indicator ensures that the indicator is visible even when the locking devices are not fully closed (for example, when one of two hooks is not engaged in the retaining axis) and when the operating handle deviates very slightly from its fully closed position. The fact that the at least one indicator, preferably two indicators on both sides of the operating handle, is arranged essentially perpendicular to the axis of rotation or pivot axis of the operating handle and on the outside of the side surfaces of the operating handle means that part of the indicator can still be recognized if the operating handle is pivoted slightly from its closed position by only a few angle degrees. This means, for example, that the flight crew is reliably alerted to the incorrect closing of the overhead luggage compartment and accidents caused by falling luggage can be avoided. In contrast, comparable indicators in conventional locking devices for overhead luggage compartments are often difficult to recognize or can only be recognized if the position of the operating handle deviates very significantly from its closed position. As with indicators of the prior art, bright, conspicuous colors are preferably used for the indicator, for example signal red or similar colors.

Advantageously, the predetermined angle range about which the operating handle is freely movable is 1° to 10°, preferably 2° to 5°. This angle range, by which the operating handle is freely pivotable before it actuates the at least one hook when the locking device is opened, can lead to a corresponding deflection of the operating handle in the case of an incompletely closed overhead luggage compartment, as a result of which the at least one indicator on the outer surface is better recognizable.

The at least one hook comprises a length of between 24 mm and 35 mm from the axis of rotation and that point which corresponds to the center of the retaining axis in the closed position. Due to this length, small changes in angle of the operating handle have a greater effect on tangential displacement, as a result of which relatively large parts of the at least one indicator become visible even with very slight pivoting of the operating handle. The specified length range shows an optimum compromise between the small size of the locking device and the longest possible lever length to achieve the largest possible displacements with small changes in angle of the operating handle.

If the at least one hook comprises an opening, preferably an oblong hole, for receiving the at least one catch, a space-saving design of the interaction between the operating handle and the hook can be achieved. In contrast to a catch of the operating handle acting externally on the hook, which can only actuate and take the hook along when the operating handle is rotated in one direction (the opening direction), when there is an opening, preferably an oblong hole, arranged in the hook, a functional coupling of the operating handle and the hook is also possible in the other direction of rotation (the closing direction). This means that by actuating the operating handle during closing of the locking device, the hook is forced into the locked position via this catch in the opening, e.g. the hook is pressed around the retaining axis. When the closed locking device is opened, the catch takes the at least one hook with it after the above-mentioned predetermined angle range by which the operating handle is freely movable has been passed over and pulls it from the retaining axis in order to achieve opening of the door of the container, preferably the luggage compartment door of the overhead luggage compartment.

According to a further feature of the invention, each hook comprises a latching protrusion for engaging each hook in the retaining axis in the closed position, which latching protrusion of each hook is designed in such a way that changes of position of the retaining axis due to tolerances and deformations of a loaded container can be compensated, preferably for changes of position between +1 mm and −6 mm. By designing the latching protrusion of the hook accordingly, together with the above-mentioned length of the hook, secure locking of the locking device and thus secure closing of the door of the container, preferably the luggage compartment door of the overhead luggage compartment, is thus achieved even with larger tolerance- or load-related deflections of the container, preferably the overhead luggage compartment. Particularly in the case of very long overhead luggage compartments, which are made of composite materials, the extreme loading results in strong deflections in the vertical direction. The hooks of conventional locking devices were no longer able to hook into the retaining axis and securely close the door of the container, preferably the luggage compartment door of the overhead luggage compartment, with the resulting displacements of the retaining axis in the vertical direction.

At least one element can be arranged on at least one hook and/or on the operating handle or integrated in the hook or operating handle, whereby a space is formed between the operating handle and the at least one hook when the operating handle is moved in the direction of the hook, that is into the closed position.

According to a first embodiment, the element can be formed by a spacer arranged or integrated on the inside of the operating handle. When the operating handle is moved into the closed position, this spacer causes the at least one hook to be taken along and thus facilitates the locking of the at least one hook to or around the retaining axis.

If the at least one spacer is formed to be elastic, a more secure locking of the at least one hook to the retaining axis can be achieved even in the event of tolerance or load-related deviations in the position of the retaining axis. The spacer, which is elastic or designed as a spring element, thus makes it possible to reduce the space between the operating handle and the hook during the closing process, which can improve the closing process. Conversely, in the case of error, that is incomplete locking of the locking device, the elastic spacer allows a greater space between (not fully) engaged hook and operating handle, which uncovers more of the at least one indicator. As a result, the case of an error can be indicated more safely and reliably.

According to an alternative embodiment, the element can also be formed by the above-mentioned opening, preferably the oblong hole, in the at least one hook, which oblong hole preferably comprises a height of between 4 mm and 12 mm. As already mentioned above, the opening or oblong hole can be used to take along the hook when the operating handle is moved in both directions, that is when the locking device is closed and when the closed locking device is opened. A spacer mentioned above between the operating handle and at least one hook is obsolete in this embodiment.

The at least one hook of the locking device is preferably spring-loaded via a leg spring, whereby the leg spring is arranged in such a way that it acts in the closing direction of the hook.

The operating handle can also be spring-loaded via a leg spring, whereby the leg spring is arranged in such a way that it acts in the closing direction of the operating handle.

The housing of the locking device is suitably formed from fire retardant thermoplastic and preferably manufactured by injection molding.

The at least one hook and the operating handle of the locking device can be formed from thermoplastic and can also preferably be manufactured by injection molding. For reinforcement, the hook and/or the operating handle may preferably comprise a core made of metal, in particular steel.

Advantageously, the locking device has two indicators for the identification of an incompletely locked state of the door, which are each arranged on the lateral outer surfaces of the operating handle and essentially perpendicular to the axis of rotation for the operating handle.

If the locking device comprises only one hook, this is preferably arranged in the center of the operating handle.

If the locking device comprises two hooks, these are ideally each arranged to the side of the operating handle.

The object according to the invention is also solved by an above-mentioned overhead luggage compartment with a locking device comprising the features described above. Reference is made to the above description of the locking device for the advantages that can be achieved as a result.

### BRIEF DESCRIPTION OF THE FIGURES

The present invention is explained in more detail with reference to the accompanying drawings. They show:

FIG. 1 a schematic representation of two overhead luggage compartments;

FIG. 2 a view of an embodiment of a locking device according to the invention with two hooks arranged on both sides of the operating handle;

FIG. 3 the locking device as shown in FIG. 2 without housing;

FIG. 4 a cross-section through the locking device shown in FIG. 2 along section line A-A with the luggage compartment door properly closed and the hook engaged respectively;

FIG. 5A a cross-section through the locking device according to FIG. 2 along section line A-A with the luggage compartment door properly closed and the hook engaged respectively;

FIG. 5B a cross-section through the locking device shown in FIG. 2 along section line B-B with the luggage compartment door incompletely closed and the hook not engaged respectively;

FIGS. 6A and 6B two cross-sections through an embodiment of a locking device with the luggage compartment door properly closed and the hook engaged respectively, with the luggage compartment door open and with the luggage compartment door incompletely closed and the hook not engaged respectively; and

FIG. 7 cross-section of a further embodiment of the locking device according to the invention with an elastic element on the operating handle.

### DETAILED DESCRIPTION

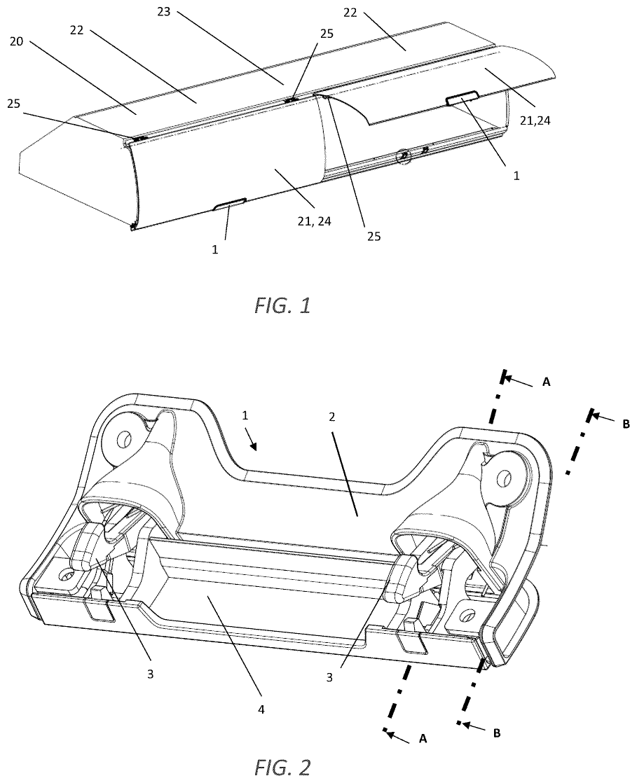

FIG. 1 shows a schematic representation of two overhead luggage compartments 22 as a special case of a container 20 with a pivotable door 21. Each overhead luggage compartment 22 contains a fixed container 23 for holding items of luggage and a luggage compartment door 24 pivotable via at least one hinge 25. In the case of the right-hand overhead luggage compartment 22, the luggage compartment door 24 is in the open position, in which loading and unloading of the container 23 is possible. On the left overhead luggage compartment 22, the luggage compartment door 24 is in the closed position. A locking device 1 is used to lock the luggage compartment door 24 in the closed position and also to unlock it again so that the luggage compartment door 24 can be opened.

FIG. 2 shows a view of an embodiment of a locking device 1 according to the invention with two hooks 3 arranged on both sides of the operating handle 4. However, the locking device 1 can also comprise only one hook 3, in which case this is preferably arranged in the center of the operating handle 4 (not shown). The locking device 1 is used to lock a pivotably mounted door 21 of a container 20, in particular a luggage compartment door 24 of an overhead luggage compartment 22, in the closed position (not shown).

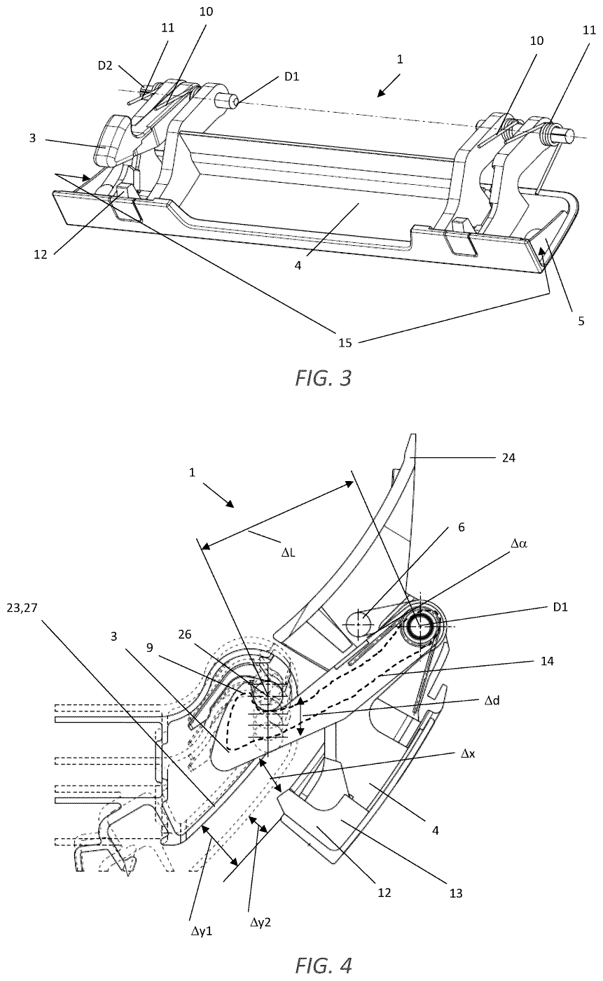

The locking device comprises a housing 2, two hooks 3 spring-loaded on the housing 2 around an axis of rotation D1 (see FIG. 3) for hooking into a retaining axis 26 arranged on the container 20 in the closed position (see FIG. 4). Furthermore, a spring-loaded pivotably mounted operating handle 4 for unlocking the hooks 3 hooked in the closed position is attached to the housing 2 about an axis of rotation D2 (see FIG. 3). The axis of rotation D1 for the two hooks 3 and the axis of rotation D2 for the operating handle 4 essentially coincide or are arranged coaxially. The housing 2 is suitably formed from fire retardant thermoplastic and preferably manufactured by injection molding. The hooks 3 and the operating handle 4 can be formed from thermoplastic and can also be preferably manufactured by injection molding. For reinforcement, the hooks 3 and/or the operating handle 4 can preferably comprise a core 14 made of metal, in particular steel (shown in dashed lines in FIG. 4). The hooks 3 can be actuated by the operating handle 4, so that the hooks 3 can be moved out of the closed position when the operating handle 4 is moved. Before the hooks 3 are unlocked, the operating handle 4 moves freely around a predetermined angle range Δα (see FIG. 4).

As can be seen more clearly in FIG. 3, where the locking device 1 according to FIG. 2 is shown without housing 2 and without right hook 3, each hook 3 can be spring-loaded via a leg spring 10, the leg spring 10 being arranged in such a way that it acts in the closing direction of the hook 3. The operating handle 4 can also be spring-loaded via a leg spring 11, whereby the leg spring 11 is arranged in such a way that it acts in the closing direction of the operating handle 4. There are two indicators 5 on the locking device 1 for identification of an incompletely locked state of the door 21, which are each arranged on the lateral outer surfaces 15 of the operating handle 4 and essentially perpendicular to the axis of rotation D2 for the operating handle 4. As a result, the indicators 5, which are usually made up of a bright color, can be easily detected even if the operating handle 4 is only very slightly pivoted relative to its locked position.

FIG. 4 shows a cross-section through the locking device 1 according to FIG. 2 along the sectional line A-A with the luggage compartment door 24 properly closed and the hooks 3 engaged. The hooks 3 can be actuated by the operating handle 4 via at least one catch 6 non-rotatably connected to the operating handle 4 in such a way that when the operating handle 4 is moved, the hook 3 can be moved out of the closed position from the retaining axis 26 via the catch 6. The operating handle 4 can be moved freely around a predetermined angle range Δα of approximately 1° to 10°, preferably 2° to 5°, before the hook 3 can be unlocked. The hook 3 comprises a length ΔL of between 24 mm and 35 mm from the axis of rotation D1 and that point which, in the closed position, corresponds to the center of the retaining axis 26. In addition, the hook 3 comprises a latching protrusion 9 for engaging in the retaining axis 26 in the closed position, which latching protrusion 9 is designed in such a way that changes of position Δd of the retaining axis 26 due to tolerances and deformations of a loaded container 20 can be compensated. Preferably, changes of position Δd between +1 mm and −6 mm should be tolerable.

According to a further feature of the invention, at least one element 12 is arranged on the hook 3 and/or on the operating handle 4 or is integrated in the hook 3 or operating handle 4, whereby a space Δx is formed between the operating handle 4 and the hook 3 when the operating handle 4 is moved in the direction of the hook 3, that is into the closed position. In the illustrated embodiment example, the element 12 is formed by a spacer 13 arranged or integrated on the inside of the operating handle 4. When the operating handle 4 is moved into the closed position, the hook 3 is taken along and forced into the closed or locked position after passing through the space Δx shown, in which the latching protrusion 9 of the hook 3 engages around the retaining axis 26. In FIG. 4, some vertically displaced positions of the retaining axis 26 due to tolerances or loading of the overhead luggage compartment 22 are illustrated with dashed lines. Even with such vertical displacements, the design and dimensions of the locking device 1 make it possible to bring it into the properly locked state. This can be facilitated by the fact that the at least one spacer 13 is elastic, as this reduces the space between the operating handle 4 and the hook 3 due to the elasticity of the spacer 13 during the closing process, making it easier to move the hook 3 around the retaining axis 26. In FIG. 4, the space Δy1 between the operating handle 4 and the fixed part 23 of the overhead luggage compartment or a lower edge profile 27 of the fixed part 23 of the overhead luggage compartment 22 is shown. If the position of the fixed part 23 of the overhead luggage compartment 22 changes due to tolerances or excessive loading (shown with dashed lines), the space Δy2 between the operating handle 4 and the lower edge profile 27 is reduced accordingly.

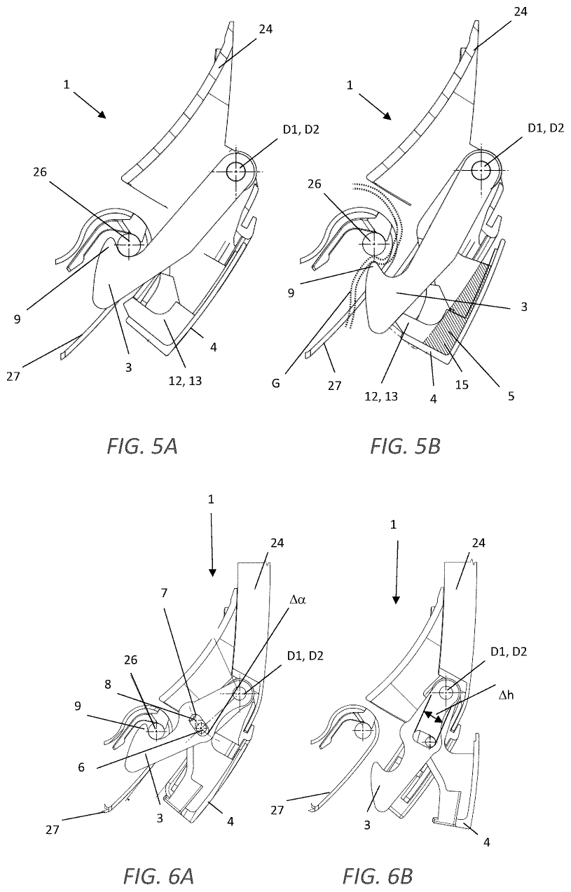

FIGS. 5A and 5B show two cross-sections through the locking device 1 as shown in FIG. 2 along section line A-A and section line B-B with the luggage compartment door 24 properly closed and the hook 3 engaged respectively (FIG. 5A) and with the luggage compartment door 24 incompletely closed and the hook 3 not engaged respectively (FIG. 5B). When the locking device 1 is properly locked as shown in FIG. 5A, the hook 3 or its latching protrusion 9 encloses the retaining axis 26 so that the luggage compartment door 24 is not opened unintentionally. The operating handle 4 is in its closed position, in which the lateral outer surfaces 15 and the indicators 5 arranged thereon are not visible and are covered by the parts of the overhead luggage compartment 22. In the view according to FIG. 5A, the indicator 5 on the lateral outer surface 15 of the operating handle 4 is not shown. FIG. 5B shows the case of error in which, for example, an object G, e.g. an item of clothing, comes to rest between hook 3 and retaining axis 26 and prevents the hook from locking about the retaining axis 26. As a result, the operating handle 4 is distanced from the hook 3 by the spacer 13, causing the operating handle 4 to pivot a certain angle from the closed position about the axis of rotation D2. Thus, the part of the lateral outer surfaces 15 of the operating handle 4 shown hatched here and thus the indicators 5 become visible. Therefore, it can quickly and clearly be identified by, for example, a flight crew that a luggage compartment door 24 is not properly locked. Usually, both lateral outer surfaces 15 of the operating handle 4 are provided with indicators 5, so that an identification of an incompletely locked locking device 1 is recognizable from both directions (in the aircraft in the direction of flight and against the direction of flight in the case of overhead compartments that are usually arranged side by side).

FIGS. 6A and 6B show two cross-sections of a variant of a locking device 1 with the luggage compartment door 24 properly closed and the hook 3 engaged respectively (FIG. 6A) and with the luggage compartment door 24 open and the hook 3 not engaged respectively (FIG. 6B). In this embodiment of the locking device 1, the hook 3 comprises an opening 7 in the form of an oblong hole 8, into which the catch 6 of the operating handle 4 protrudes. The oblong hole 8 in the hook 3 preferably comprises a height Ah of between 4 mm and 12 mm. Due to this design, the oblong hole 8 acts as an element 12 when the operating handle 4 is moved into the closed position, which takes along the hook 3 during this movement of the operating handle 4. When the operating handle 4 is moved into the closed position, that is in the direction of the hook 3, the catch 6 reaches the upper end of the oblong hole 8 and then takes the hook 3 with it accordingly and moves it into the closed position. In this embodiment, the spacer 13 (see FIG. 4) is not necessary. An elastic design is also theoretically possible by making the material of the hook 3 above the upper end of the oblong hole 8 elastic.

When the locking device 1 is properly locked as shown in FIG. 6A, the hook 3 or its latching protrusion 9 encloses the retaining axis 26 so that the luggage compartment door 24 is not opened unintentionally. The operating handle 4 is in its closed position, in which the lateral outer surfaces 15 and the indicators 5 arranged thereon are not visible and are covered by the parts of the overhead luggage compartment 22. FIG. 6B shows the locking device 1 in the open state, in which the operating handle 4 is pivoted from the closed position about the axis of rotation D2 (counterclockwise in this case) until the catch 6 reaches the lower or right-hand end of the oblong hole 8 on the hook 3 and thus actuates it and pivots it about the axis of rotation D1. As a result, the hook 3 and the latching protrusion 9 of the hook 3 respectively is pulled out of the locked position from the retaining axis 26 and the luggage compartment door 24 can be opened.

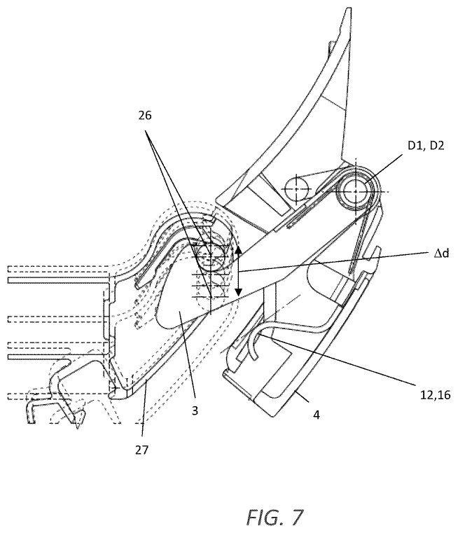

Finally, FIG. 7 shows a further embodiment of the locking device 1 according to the invention with an elastic spacer 13 on the operating handle 4. In contrast to the embodiment according to FIG. 4, the element 12, which causes the hook 3 to be taken along while maintaining a distance when the operating handle 4 is moved towards the hook 3, that is into the closed position, is not formed by a spacer 13 but by a spring element 16. The spring element 16 can be compressed during the closing process, which reduces the space between operating handle 4 and hook 3. This reduction in space allows the hook 3 to be properly locked about the retaining axis 26 even if the retaining axis 26 is displaced downwards in the vertical direction due to tolerances or excessive loading of the fixed part 23 of the overhead luggage compartment 22. The change of position Δd of the retaining axis 26 is shown in dashed lines in FIG. 7.

The present locking device 1 provides an optimal and safe indicator of an incompletely locked position to ensure that the luggage compartment door 24 of the overhead luggage compartment 22 does not swing open in an uncontrolled manner and that items of luggage stored in the fixed part 23 of the overhead luggage compartment 22 do not fall out and cause injury to passengers.

Furthermore, the special design of the locking device 1, in particular the length AL of the hook 3, makes it possible to close the locking device 1 more securely even if the fixed part 23 of the overhead luggage compartment 22 is deflected. The locking device 1 can be manufactured relatively easy and inexpensively and is free of electronic components.

1. Locking device for locking a pivotably mounted door of a container, having a housing, at least one hook pivotably mounted on the housing about an axis of rotation for hooking into a retaining axis arranged on the container in the closed position, an operating handle pivotably spring-mounted on the housing about an axis of rotation for unlocking the at least one hook hooked in the closed position, wherein the axis of rotation for the at least one hook and the axis of rotation for the operating handle are arranged coaxially, the at least one hook can be actuated by the operating handle via at least one catch non-rotatably connected to the operating handle in such a way that, when the operating handle is moved via the at least one catch, the at least one hook can be moved out of the closed position, and with at least one indicator for the identification of an incompletely locked state of the door, wherein the at least one indicator for indicating an incompletely locked state of the door is arranged on at least one lateral outer surface of the operating handle and essentially perpendicular to the second axis of rotation for the operating handle, wherein the operating handle is freely movable around a predetermined angle range before the at least one hook can be unlocked and the at least one hook comprises an oblong hole for receiving the at least one catch.

2. Locking device according to claim 1, wherein the predetermined angle range about which the operating handle is freely movable is 1° to 10°.

3. Locking device according to claim 1, wherein the at least one hook comprises a length of between 24 mm and 35 mm from the axis of rotation and that point which, in the closed position, corresponds to the center of the retaining axis.

4. Locking device according to claim 1, wherein each hook comprises a latching protrusion for latching each hook in the retaining axis in the closed position, which latching protrusion encloses the retaining axis when the locking device is properly closed.

5. (canceled)

6. Locking device according to claim 1, wherein at least one element is arranged on at least one hook and/or on the operating handle or is integrated into the hook or operating handle, whereby a space is formed between the operating handle and the at least one hook when the operating handle is moved in the direction of the hook, that is into the closed position.

7. Locking device according to claim 6, wherein the element is formed by a spacer arranged or integrated on the inside of the operating handle.

8. Locking device according to claim 7, wherein the at least one spacer is formed to be elastic.

9. Locking device according to claim 7, wherein the element is formed by the oblong hole in the at least one hook.

10. Overhead luggage compartment with a fixed container and a luggage compartment door pivotable via at least one hinge and a locking device for locking the luggage compartment door in the closed state, wherein the locking device is designed according to claim 1.

11. Locking device according to claim 1, wherein the pivotably mounted door of a container is a luggage compartment door of an overhead luggage compartment.

12. Locking device according to claim 2, wherein the predetermined angle range about which the operating handle is freely movable is 2° to 5°.

13. Locking device according to claim 9, wherein oblong hole comprises a height between 4 mm and 12 mm.
